(19) United States
(12) Patent Application Publication
(10) Pub. No.: US 2018/0331644 A1
(43) Pub. Date: Nov. 15, 2018

(54) CURRENT CONVERSION METHOD AND DEVICE, VEHICLE COMPRISING SUCH A DEVICE

(71) Applicants: UNIVERSITÉ BLAISE PASCAL-CLERMONT II, CLERMONT FERRAND (FR); CENTRE NATIONAL DE LA RECHERCHE SCIENTIFIQUE, PARIS (FR)

(72) Inventors: KHALIL EL KHAMLICHI DRISSI, COURNON (FR); ABBAS DEHGHANIKIADEHI, CLERMONT FERRAND (FR); CHRISTOPHE PASQUIER, DALLET (FR)

(21) Appl. No.: 15/775,821

(22) PCT Filed: Nov. 8, 2016
(86) PCT No.: PCT/FR2016/052887

§ 371 Date: May 11, 2018

(30) Foreign Application Priority Data
Nov. 12, 2015 (FR) 1560796

(51) Int. Cl. H02P 21/06; H02P 21/22

(52) U.S. Cl. CPC H02P 21/06; H02P 21/22

(57) ABSTRACT

A current conversion method for an electrical device. The electrical device includes a three-phase electric motor and two three-phase inverters. Each inverter is controlled by modulation of at least six non-zero space vectors or space vector modulation. The output voltage of each inverter is given by a reference space vector. For each inverter, the method includes modulating the space vectors by a space-vectors activation sequence having at least two switching intervals in which three adjacent space vectors are used. A device to convert current and a vehicle implementing the current conversion method are provided.

### TECHNICAL FIELD

The present invention relates to a current conversion method and device, and a vehicle comprising such a device.

The present invention applies to the field of current conversion for devices comprising a three-phase electric motor.

More specifically, the present invention applies to electric or hybrid vehicles such as cars, trains or trams, for example. The present invention also applies to “smart” electricity distribution networks (commonly called “Smartgrids”). In addition, the invention applies to any electrical device, such as portable electric chainsaws or washing machines, for example.

### BACKGROUND OF THE INVENTION

Using two three-phase inverters is known from the state of the art. In particular, in French patent application number FR 15 50045, filed on 6 Jan. 2015 and not yet published, two three-phase inverters are connected to a three-phase motor and controlled by activating two adjacent space vectors. However, in such a device, the zero space vectors are activated, which leads to losses due to three-sequence harmonics in the output signal. The three-sequence harmonics are due to zero voltages, also called “Zero Sequence Voltages”, with the acronym ZSV.

Several scientific publications propose means for reducing the ZSV or the zero current, also called “Zero Sequence Current”, with the acronym ZSC. In particular, the reduction can be made by a dynamic balancing. However, such a balancing is hardly effective for increased modulation index values. In addition, such a balancing requires complex calculations and additional passive components.

There is also a method for reducing losses due to switching and the voltage in common mode, also called “Common Mode Voltage”, with the acronym CMV, for which one single inverter is controlled by three active and adjacent space vectors.

This device has a disadvantage, that of limiting the fundamental output voltage to 89% of the reachable fundamental voltage.

However, the methods and devices cited above have solutions involving elements such as batteries or inductances of significant volume that are difficult to adapt to an electric vehicle.

### OBJECT OF THE INVENTION

The present invention aims to remedy these disadvantages, in whole or in part. For instance, the present invention aims to minimise the losses due to phase switching and to remove the three-sequence harmonic on the output signal of the inverters.

To this end, according to a first aspect, the present invention relates to a current conversion method for an electrical device comprising:
a three-phase electric motor (245),
two three-phase inverters (O1, O2, 225, 235), each inverter being controlled by a modulation of at least six non-zero space vectors (or SVM: acronym for “Space Vector Modulation”), the output voltage of each inverter being given by a space vector termed “reference space vector”,

which comprises, for each inverter, a step of modulating space vectors by an activation sequences of the space vectors comprising at least two switching intervals in which, three adjacent space vectors are implemented.

Thanks to these arrangements, the three-sequence harmonic of the supply current of the electric motor is close to zero. In addition, losses due to phase switching are decreased. In addition, the switching frequency is decreased by thirty-three percent compared with a Conventional Space Vector Modulation (with the acronym CSVM).

In the embodiments, for each activation sequence, for each passage from a switching interval to another switching phase, a phase of the three-phase electric motor is kept unchanged and each other phase of the three-phase electric motor switches from a predetermined voltage to the opposite of said voltage.

The advantage of these embodiments is to limit the amount of phase switching of the electric motor, increasing the lifespan of the electric motor.

In the embodiments, for at least one inverter, the cyclical ratio of three adjacent space vectors Vᵢ₋₁, Vᵢ and Vᵢ₊₁, implemented on a switching interval Tₛ, is:

$$\begin{matrix}{α}_{i - 1 , x} = 1 - \frac{2 \sqrt{3}}{π} {M}_{x} sin ( {θ}_{x}^{′} ) , where {θ}_{x}^{′} = {θ}_{x} - \frac{( i - 2 ) π}{3} & ( A ) \\ {α}_{i , x} = - 1 + \frac{6}{π} {M}_{x} sin ( {θ}_{x}^{′} + \frac{π}{6} ) & ( B ) \\ {α}_{i + 1 , x} = 1 - \frac{2 \sqrt{3}}{π} {M}_{x} sin ( {θ}_{x}^{′} + \frac{π}{3} ) & ( C )\end{matrix}$$

with α_{i-1,x} the cyclical ratio of the space vector Vᵢ₋₁, α_{i,x} the cyclical ratio of the space vector Vᵢ, and α_{i+1,x} the cyclical ratio of the space vector Vᵢ₊₁, i is a whole number between one and six, θₓ is the angle between the reference vector and the abscissa of an orthonormal marker, with x a whole number between 1 and 2, and Mₓ is a real number between 0 and 1 termed as “modulation index”.

These embodiments have the advantage of decreasing the total harmonic distortions.

In the embodiments, the method that is the subject matter of the present invention, comprises a step of adjusting at least one modulation index Mₓ according to the amplitude of the root of the input signal of the three-phase motor.

Thanks to these arrangements, the modulation index is adjusted to product a better efficiency of the electrical device.

In the embodiments, the method that is the subject matter of the present invention, comprises a step of adapting at least one phase angle between the phases of the three-phase motor according to the amplitude of the root of the input signal of the three-phase motor.

The advantage of these embodiments is to adapt the phase angle to improve the efficiency of the electrical device and decrease losses. In particular, by adapting the phase angle and adjusting the modulation index, distortions due to the harmonics are close to zero.

In the embodiments, the activation sequence of the first inverter is identical and synchronised to the activation sequence of the second inverter.

These embodiments enable to decrease a third of the amount of switching compared with a modulation of conventional space vectors. According to a second aspect, the present invention relates to a current conversion device for an electrical device comprising:
a three-phase electric motor,
two three-phase inverters, each inverter being controlled by a modulation of at least six space vectors (or SVM: acronym for “Space Vector Modulation”), the output voltage of each inverter being given by a space vector termed “reference space vector”,

which comprises, means for controlling each inverter by an activation sequence of space vectors implementing a method that is the subject matter of the present invention.

With the specific advantages, aims and characteristics of the device that is the subject matter of the present invention being similar to those of the method that is the subject matter of the present invention, they are not reminded of here.

According to a third aspect, the present invention relates to a vehicle comprising:
a three-phase electric motor,
two three-phase inverters, each inverter being controlled by a modulation of at least six space vectors (or SVM: acronym for “Space Vector Modulation”), the output voltage of each inverter being given by a space vector termed “reference space vector” and
means for controlling each inverter by an activation sequence of space vectors implementing a method that is the subject matter of the present invention.

With the specific advantages, aims and characteristics of the vehicle that is the subject matter of the present invention being similar to those of the method that is the subject matter of the present invention, they are not reminded of here.

### BRIEF DESCRIPTION OF THE DRAWINGS

Other specific advantages, aims and characteristics of the invention will emerge from the non-limitative description which follows at least one specific embodiment of a method, a device and a vehicle that are the subject matter of the present invention, opposite the appended drawings, wherein:

FIG. 1 schematically represents a first specific embodiment of a method that is the subject matter of the present invention;

FIG. 2 schematically represents a first specific embodiment of a device that is the subject matter of the present invention;

FIG. 3 schematically represents the output current values of the two inverters on an orthonormal marker (α, β);

FIG. 4 schematically represents the space vectors for each three-phase inverter of a current conversion device that is the subject matter of the present invention; and

FIG. 5 schematically represents a vehicle that is the subject matter of the present invention.

### DESCRIPTION OF EXAMPLES OF EMBODIMENTS OF THE INVENTION

From now, it is noted that the figures are not to scale.

The present description is given in a non-limitative way, each characteristic of an embodiment could be combined with any other characteristic of any other embodiment advantageously.

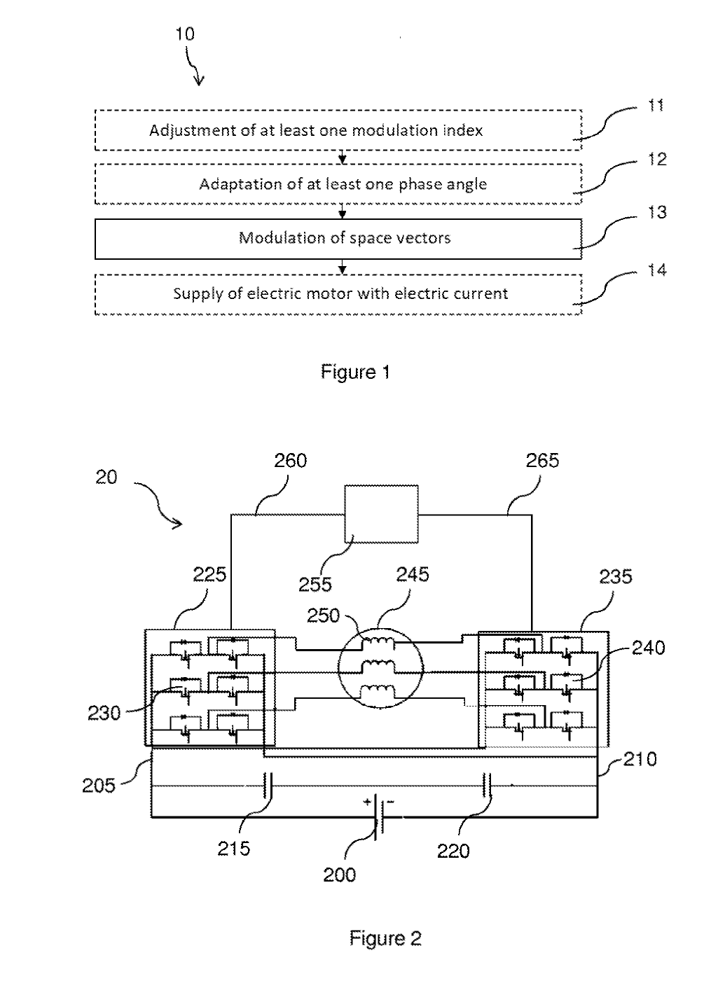

A specific embodiment 10 of a method that is the subject matter of the present invention is observed in FIG. 1. In FIG. 1, the steps in a dotted line correspond to the specific embodiments of the method that is the subject matter of the present invention. A specific embodiment of a device that is the subject matter of the present invention is observed in FIG. 2. The description which follows is the simultaneous description in FIGS. 1 and 2.

The method 10 that is the subject matter of the present invention is for an electrical device 20 comprising:
a three-phase electrical motor 245 and
two three-phase inverters, 225 and 235, each inverter being controlled by a modulation of at least six space vectors V₁, V₂, V₃, V₄, V₅ and V₆, non-zero (or SVM: acronym for “Space Vector Modulation”), the output voltage of each inverter being given by a space vector termed “reference space vector”.

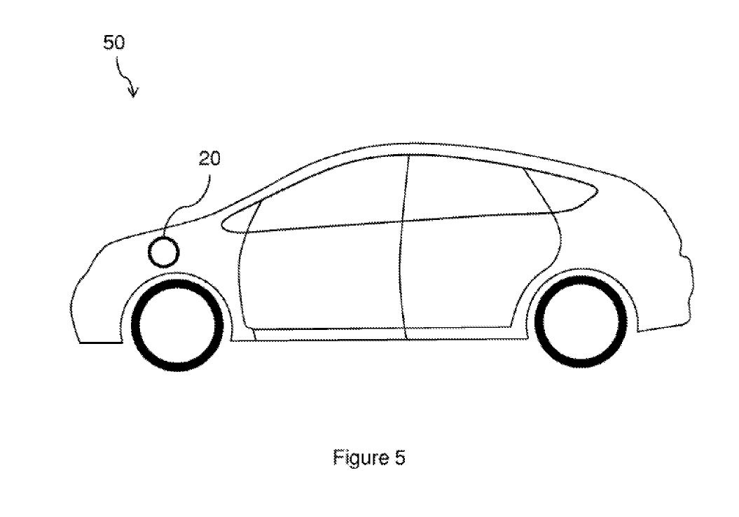

The six space vectors, V₁, V₂, V₃, V₄, V₅ V₆ of each inverter, 225 and 235, are defined as having the same standard and such that the angle between the direction of a vector Vᵢ and the direction of a vector Vᵢ₊₁, with i a whole number between one and six, is sixty degrees. By defining the origin of the six space vectors V₁, V₂, V₃, V₄, V₅ V₆, at the same determined point of an orthonormal marker (α, β), the ends of the space vectors V₁, V₂, V₃, V₄, V₅ V₆ define a regular hexagon. For each inverter, 225 and 235, the vector V₁ is defined as being parallel to the axis a of the orthonormal marker (α, β) and the angle between the direction of a vector Vᵢ and the direction of a vector Vᵢ₊₁ is sixty degrees in the anti-clockwise direction. The representation of the space vectors can be seen in FIG. 4.

The two vectors V₀ and V₇ correspond to the zero vectors and are positioned at the centre of the regular hexagon defined by the space vectors V₁, V₂, V₃, V₄, V₅ V₆.

The inverter, 225 or 235, comprises six power switches which are controlled by the modulation means 255. Three pairs of power switches are connected in parallel. The power switches have two states, the open state or the closed state. To activate one power switch per pair, in open or closed state, the other power switch is controlled in the additional state. The space vectors V₁, V₂, V₃, V₄, V₅ V₆ each correspond to a different activation combination of the six power switches. The activation sequence of the space vectors corresponds to an activation sequence of the power switches. The vector V₀ corresponds to the closure of the first switches receiving the current for each pair of switches. The vector V₇ corresponds to the opening of the first switches receiving the current for each pair of switches. The first inverter 225 comprises each power switch 230 and the second inverter 235 comprises each power switch 240.

A power switch, 230 or 240, can be a diode and a transistor connected in parallel. Preferably, the power switches, 230 or 240, are MOSFET transistors (acronym for: “Metal Oxide Semiconductor Field Effect Transistor”) or IGBT transistors (acronym for: “Insulated Gate Bipolar Transistor”).

The means for supplying 200 a direct current source can be an autonomous electrical supply source or an electricity source connected to the national electricity distribution network.

The connection means, 205 and 210, can be electrical conductors. The connection means can comprise condensers 215 and 220 filtering the current ripples of a D.C. bus. The value of the capacity of the condensers 215 and 220 depends on a current ripple rate of the D.C. bus. The D.C. bus is crossed by the electrical output current of the supply means 200.

Preferably, the electric motor 245 is a three-phase asynchronous motor. The electric motor 245 comprises three phases pA, pB and pC.

Preferably, the inverters 225 and 235 are identical and connected on either side in relation to the electric motor 250. The corresponding phases of each three-phase inverter, 225 or 235, are connected on one same phase, pA, pB or pC of the electric motor 250.

The control means 255 of each inverter, 225 or 235, by an activation sequence, 260 or 265, of space vectors implementing a method 10 that is the subject matter of the present invention. The control means 255 are preferably a microcontroller generating a digital control signal for the period Tₛ equal to one switching interval.

Subsequently in the description, the space vectors of the first inverter 225 and of the second inverter 235 are referenced V₁, V₂, V₃, V₄, V₅ V₆.

The method 10 comprises, for the first inverter 225, a step of modulating 13 the space vectors V₁, V₂, V₃, V₄, V₅ V₆ by an activation sequence 260 of the space vectors V₁, V₂, V₃, V₄, V₅ V₆, comprising at least two switching intervals wherein three adjacent space vectors are implemented.

The method 10 comprises, for the second inverter 235, a step of modulating 13 the space vectors V₁, V₂, V₃, V₄, V₅ V₆, by an activation sequence 265 of the space vectors V₁, V₂, V₃, V₄, V₅ V₆, comprising at least two switching intervals wherein three adjacent space vectors are implemented.

Preferably, the activation sequence 260 of the first inverter 225 comprises six switching intervals. Each switching interval is defined by a period Tₛ. Preferably, the period Tₛ of each switching interval does not vary.

The activation sequence 260 comprises the following intervals:
for the first switching interval, the adjacent vectors implemented are the vectors V₆, V₁ and V₂,
for the second switching interval, the adjacent vectors implemented are the vectors V₁, V₂ and V₃,
for the third switching interval, the adjacent vectors implemented are the vectors V₂, V₃ and V₄,
for the fourth switching interval, the adjacent vectors implemented are the vectors V₃, V₄ and V₅,
for the fifth switching interval, the adjacent vectors implemented are the vectors V₄, V₅ and V₆,
for the sixth switching interval, the adjacent vectors implemented are the vectors V₅, V₆ and V₁.

For each switching interval, the vector representing the output voltage Vₛ¹ of the first inverter 225 is comprised in a sector of the representation 40 in FIG. 4 of the space vectors V₁, V₂, V₃, V₄, V₅ V₆ summarised in table 1.

TABLE 1

| | | First maximum | Second high | |
|---|---|---|---|---|
| | Vectors | angle in | maximum angle | Phase kept |
| Sector | implemented | relation to α | in relation to α | unchanged |
| 410a | V₆, V₁ and V₂ | 330° | 30° | pA |
| 415a | V₁, V₂ and V₃ | 30° | 90° | pC |
| 420a | V₂, V₃ and V₄ | 90° | 150° | pB |
| 425a | V₃, V₄ and V₅ | 150° | 210° | pA |
| 430a | V₄, V₅ and V₆ | 210° | 270° | pC |
| 435a | V₅, V₆ and V₁ | 270° | 330° | pB |

The maximum angles in relation to a are illustrated in FIG. 4. The first and second maximum angle in relation to a mean the sector of the hexagon formed by the vectors V₁, V₂, V₃, V₄, V₅ V₆ wherein Vₛ¹ is situated for each switching interval.

Preferably, the activation sequence 265 of the second inverter 235 comprises six switching intervals. Each switching interval is defined by a period Tₛ′. Preferably, the period Tₛ′ of each switching interval is invariant. Preferably, the period Tₛ of the switching intervals of the activation sequence 260 of the first inverter 225 is equal to the period Tₛ′ of the switching intervals of the activation sequence 265 of the second inverter 235.

The activation sequences 265 of the second inverter 235 comprises the same switching intervals as the activation sequences 260 of the first inverter 225.

For each switching interval, the vector representing the output voltage Vₛ² of the second inverter 235 is comprised in a sector of the representation 40 in FIG. 4 of the space vectors V₁, V₂, V₃, V₄, V₅ V₆, summarised in table 1.

During the modulation step 13, for each activation sequence, 260 or 265, for each passage of a switching interval to another switching interval, a phase, pA, pB or pC, of the three-phase electric motor is kept unchanged and each other phase, pA, pB or pC, of the three-phase electric motor switches from a predetermined voltage to the opposite of said voltage.

The output vector of the pair of inverters and supplying the motor Vₘ is given by the following equation:

Vₘ=Vₛ¹−Vₛ² (D)

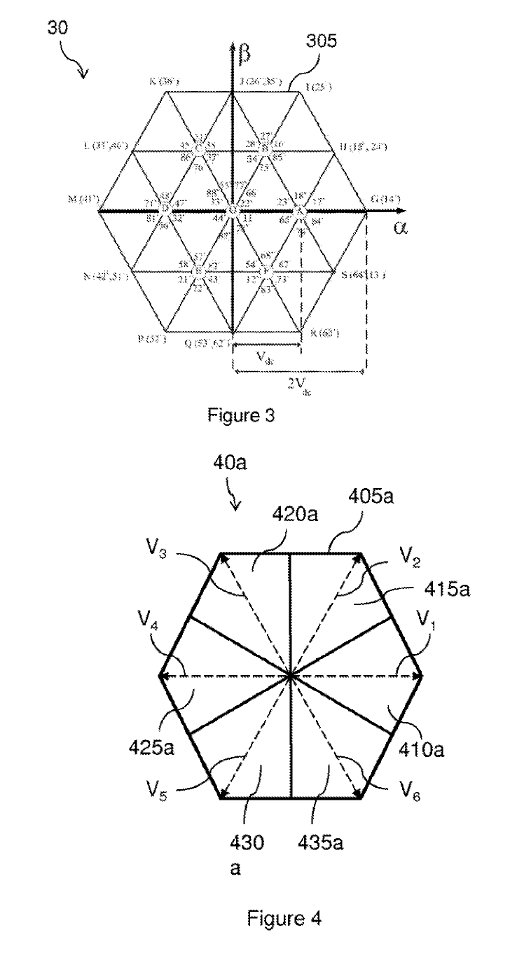

Thus, for the combination of vectors V₀, V₁, V₂, V₃, V₄, V₅ V₆, V₇ of each inverter, 225 and 235, the vector Vₘ can have one of the combinations represented in FIG. 3. In FIG. 3, each point A, B, C, D, E, F, G, H, I, J, K, L, M, N, O, P, Q, R, S represents a possible vector Vₘ. The numbers to the side of each one of the points indicate each combination of output vector of the inverter 225 and of output vector of the inverter 235 for obtaining the vector Vₘ in this point.

For example, to the side of point A, the FIG. 17′, indicate that Vₘ can be obtained if Vₛ¹ is equal to V₁ and if Vₛ² is equal to V₇.

Sixty-four combinations of space vectors of the inverters 225 and 235 are possible to obtain Vₘ and the points A, B, C, D, E, F, G, H, I, J, K, L, M, N, O, P, Q, R or S.

In preferable embodiments, the activation sequence 260 of the first inverter 225 is identical and synchronised to the activation sequence 265 of the second inverter 235.

In the embodiments, for the first inverter 225, the cyclical ratio of three adjacent space vectors Vᵢ₋₁, Vᵢ and Vᵢ₊₁, implemented on a switching interval, is:

$$\begin{matrix}{α}_{i - 1 , 1} = 1 - \frac{2 \sqrt{3}}{π} {M}_{1} sin ( {θ}_{1}^{′} ) , where {θ}_{1}^{′} = {θ}_{1} - \frac{( i - 2 ) π}{3} & ( A ) \\ {α}_{i , 1} = - 1 + \frac{6}{ π} {M}_{1} sin ( {θ}_{1}^{′} + \frac{π}{6} ) & ( B ) \\ {α}_{i + 1 , 1} = 1 - \frac{2 \sqrt{3}}{π} {M}_{1} sin ( {θ}_{1}^{′} + \frac{π}{3} ) & ( C )\end{matrix}$$

with α_{i-1,1} the cyclical ratio of the space vector Vᵢ₋₁, α_{i,1} the cyclical ratio of the space vector Vᵢ, and α_{i+1,1} the cyclical ratio of the space vector Vᵢ₊₁, i is a whole number between one and six, θ₁ is the angle between the reference vector and the abscissa of an orthonormal marker, and M₁ is a real number between 0 and 1 termed “modulation index”.

In the embodiments, for the second inverter 235, the cyclical ratio of three adjacent space vectors Vᵢ₋₁, Vᵢ and Vᵢ₊₁, implemented on a switching interval, is:

$$\begin{matrix}{α}_{i - 1 , 2} = 1 - \frac{2 \sqrt{3}}{π} {M}_{2} sin ( {θ}_{2}^{′} ) , where {θ}_{2}^{′} = {θ}_{2} - \frac{( i - 2 ) π}{3} & ( A ) \\ {α}_{i , 2} = - 1 + \frac{6}{ π} {M}_{2} sin ( {θ}_{2}^{′} + \frac{π}{6} ) & ( B ) \\ {α}_{i + 1 , 2} = 1 - \frac{2 \sqrt{3}}{π} {M}_{2} sin ( {θ}_{2}^{′} + \frac{π}{3} ) & ( C )\end{matrix}$$

with α_{i-1,2} the cyclical ratio of the space vector Vᵢ₋₁, α_{i,2} the cyclical ratio of the space vector Vᵢ, and α_{i+1,2} the cyclical ratio of the space vector Vᵢ₊₁, i is a whole number between one and six, θ₂ is the angle between the reference vector and the abscissa of an orthonormal marker, and M₂ is a real number between 0 and 1 termed “modulation index”.

Preferably, the modulation index Mₓ, with x a whole number between 1 and 2, is the ratio between the maximum value of the root of the reference vector and the maximum value of a square signal. The modulation index Mₓ, is expressed by the following formula:

$${M}_{x} = \frac{{V}_{1}^{x}}{\frac{2}{π} {V}_{d c}} . \qquad ( E )$$

In the embodiments, the method 10 comprises a step of adjusting 11 at least one modulation index Mₓ according to the amplitude of the root of the input signal of the three-phase motor. Preferably, each output space vector of each inverter is adjusted to be in the linear range. In the linear range, the modulation index is between sixty-one hundredths and nine hundred and seven thousandths. The weighted total harmonic distortion (with the acronym WTHD) of each output phase of the inverter enables to highlight a modulation index for which the total harmonic distortion is minimal.

The weighted total harmonic distortion is defined by the following equation:

$$W T H D = \frac{\sqrt{{\sum }_{n = 2}^{∞} {( \frac{{V}_{n}}{n} )}^{2}}}{{V}_{1}} \qquad ( F )$$

with n the harmonic sequence, Vₙ the amplitude of the odd harmonic of sequence n of the voltage Vₘ at the terminals of a phase of the motor.

The curve representing the weighted total harmonic distortion according to the modulation index shows a minimum of six thousandths when the modulation index is equal to eight hundred and eight thousandths.

Preferably, during the adjustment step 11, the modulation index Mₓ is set equal to eight hundred and eight thousandths. In these embodiments, the harmonic distortion is minimised and the current ripples are diminished.

In the embodiments, the method 10 comprises a step of adapting 12 at least one phase angle between the phases of the three-phase motor according to the amplitude of the root of the input signal of the three-phase motor.

The voltage Vₘ on a phase of the motor is given by the development of the Fourier series:

$$\begin{matrix}{v}_{m} = {V}_{1}^{t} cos ( ω t + {θ}_{1}^{t} ) + … + {v}_{n}^{t} cos ( n ω t + {θ}_{n}^{t} ) & ( G ) \\ with & \\ {V}_{1}^{t} = {V}_{1}^{1} \sqrt{1 + {( {a}_{1} )}^{2} - 2 {a}_{1} cos ( {ϕ}_{1}^{1} - {ϕ}_{1}^{2} )} and & \\ {θ}_{1}^{t} = \frac{{ϕ}_{1}^{1} + {ϕ}_{1}^{2}}{2} + atan ( \frac{{a}_{1} - 1}{{a}_{1} + 1} cot g ( \frac{{ϕ}_{1}^{1} - {ϕ}_{1}^{2}}{2} ) ) & \\ {V}_{n}^{t} = {V}_{n}^{1} \sqrt{1 + {( {a}_{n} )}^{2} - 2 {a}_{n} cos ( {ϕ}_{n}^{1} - {ϕ}_{n}^{2} )} and & \\ {θ}_{n}^{t} = \frac{{ϕ}_{n}^{1} + {ϕ}_{n}^{2}}{2} + atan ( \frac{{a}_{n} - 1}{{a}_{n} + 1} cot g ( \frac{{ϕ}_{n}^{1} - {ϕ}_{n}^{2}}{2} ) ) & \\ with & \\ {a}_{1} = \frac{{V}_{1}^{2}}{{V}_{1}^{1}} and {a}_{n} = \frac{{V}_{n}^{2}}{{V}_{n}^{1}} & ( H )\end{matrix}$$

where φₙ¹ is the phase angle of the harmonic of output value n of the first inverter on the phase pA of the motor, φₙ² is the phase angle of the harmonic of output value n of the second inverter on the phase pA,

where Vₙ¹ is the amplitude of the harmonic of output value n of the first inverter on the phase pA of the motor, Vₙ² is the amplitude of the harmonic of output value n of the second inverter on the phase pA.

Considering that the two inverters function on the same modulation index M₁=M₂, V₁¹=V₁² is defined in the equation I and V₁¹ is the amplitude of the output root of the first inverter 225 on the phase pA which is equal to the amplitude of the output root of the second inverter 235 on the phase pA.

Likewise, the amplitude of the harmonics of output sequence n of the first inverter 225 is equal to the amplitude of the harmonics of output sequence n of the second inverter 235, Vₙ¹=Vₙ².

$${V}_{1}^{1} = \frac{2}{n} {V}_{d c} {M}_{1} \qquad ( I )$$

with V_{dc} a predetermined supply voltage.

Under these conditions, α₁=αₙ=1, hence:

$$\begin{matrix}{V}_{1}^{t} = 2 {V}_{1}^{1} sin ( \frac{{ϕ}_{1} - {ϕ}_{2}}{2} ) and {θ}_{1}^{t} = \frac{{ϕ}_{1}^{1} + {ϕ}_{1}^{2}}{2} & ( J ) \\ {V}_{n}^{t} = 2 {V}_{n}^{1} sin ( \frac{{ϕ}_{n}^{1} - {ϕ}_{n}^{2}}{2} ) and {θ}_{n}^{t} = \frac{{ϕ}_{n}^{1} + {ϕ}_{n}^{2}}{2} & ( K )\end{matrix}$$

The maximum voltage V₁^{t} is extracted from the equation J for the phase pA at the fundamental frequency defined below in equation L:

$${V}_{1}^{t} = \frac{4}{π} {V}_{d c} {M}_{1} sin ( \frac{{ϕ}_{1} - {ϕ}_{2}}{2} ) \qquad ( L )$$

The voltage V₁^{t} depends on the modulation index M₁ and the phase angle φ₁−φ₂.

Preferably, the phase angle φ₁−φ₂ is a multiple of

$$\frac{2 π}{3}$$

radians. In these embodiments, the amplitude of the harmonics that are multiples of three is zero and the weighted total harmonic distortion (WTHD) is considerably decreased.

Preferably, the adjustment step 11 is implemented if the phase angle φ₁−φ₂ is set as being a multiple of

$$\frac{2 π}{3}$$

radians and the adaptation step 12 is implemented when the modulation index M₁ is set as being equal to eight hundred and eight thousandths.

In the embodiments, the adjustment 11 and adaptation 12 steps are implemented simultaneously.

The method 10 can comprise a step 14 of electrically supplying the electric motor 245 with electrical voltage. The electrical voltage supplying each phase pA, pB and pC of the electric motor 245 is the result of the different in electrical voltage represented by an output space vector Vₛ¹ of the first inverter 225 and of the electrical voltage represented by an output space vector Vₛ² of the second inverter 235.

A specific embodiment 50 of a vehicle that is the subject matter of the present invention is observed in FIG. 5.

The vehicle 50 can be any type of electric or hybrid vehicle, such as a car, a train or a tram, for example.

The vehicle 50 comprises an embodiment 20 of a device that is the subject matter of the present invention. The embodiment 20 of the device that is the subject matter of the present invention is preferably connected to the direct current supply means of the vehicle 50 and to a three-phase electric motor of the vehicle 50. The vehicle 50 comprises control means 255 of each inverter, 225 or 235, by an activation sequence, 260 or 265, of space vectors implementing a method 10 that is the subject matter of the present invention.

1-8. (canceled)

9. A current conversion method for an electrical device comprising a three-phase motor and two three-phase inverters, each inverter being controlled by a space vector modulation of at least non-zero six space vectors and an output voltage of each inverter being given by a reference space vector, the method comprising, for each inverter, a step of modulating the space vectors by an activation sequence of the space vectors comprising at least two switching intervals in which three adjacent space vectors are implemented.

10. The current conversion method according to claim 9, wherein for each passage from one switching interval to another switching interval for each activation sequence, a phase of the three-phase electric motor is kept unchanged and each other phase of the three-phase electric motor switches from a predetermined voltage to an opposite of said predetermined voltage.

11. The current conversion method according to claim 9, wherein, for at least one inverter, a cyclical ratio of each of the three adjacent space vectors, Vᵢ₋₁, Vᵢ and Vᵢ₊₁, implemented on a switching interval is:
$$\begin{matrix}{α}_{i - 1 , x} = 1 - \frac{2 \sqrt{3}}{π} {M}_{x} sin ( {θ}_{x}^{′} ) , where {θ}_{x}^{′} = {θ}_{x} - \frac{( i - 2 ) π}{3} & ( A ) \\ {α}_{i , x} = - 1 + \frac{6}{π} {M}_{x} sin ( {θ}_{x}^{′} + \frac{π}{6} ) & ( B ) \\ {α}_{i + 1 , x} = 1 - \frac{2 \sqrt{3}}{π} {M}_{x} sin ( {θ}_{x}^{′} + \frac{π}{3} ) & ( C )\end{matrix}$$
where α_{i-1,x} is the cyclical ratio of the space vector Vᵢ₋₁, α_{i,x} is the cyclical ratio of the space vector Vᵢ, and α_{i+1,x} is the cyclical ratio of the space vector Vᵢ₊₁, i is a whole number between one and six, θₓ is an angle between the reference space vector and an abscissa of an orthonormal marker, x is a whole number between 1 and 2, and Mₓ is modulation index, a real number between 0 and 1.

12. The current conversion method according to claim 11, further comprising a step of adjusting at least one of the modulation index Mₓ according to an amplitude of a root of an input signal of the three-phase motor.

13. The current conversion method according to claim 9, further comprising a step of adapting at least one phase angle between phases of the three-phase motor according to an amplitude of a root of the input signal of the three-phase motor.

14. The current conversion method according to claim 9, wherein the activation sequence of one of the two three-phase inverters is identical and synchronised to the activation sequence of the other three-phase inverter.

15. A current conversion device for an electrical device, comprising:
a three-phase electrical motor;
two three-phase inverters, each inverter being controlled by a space vector modulation of at least non-zero six space vectors and an output voltage of each inverter being given by a reference space vector; and
a controller to control each of the two three-phase inverters by an activation sequence of space vectors implementing the current conversion method according to claim 9.

16. A vehicle comprising:
a three-phase electrical motor;
two three-phase inverters, each inverter being controlled by a space vector modulation of at least non-zero six space vectors and an output voltage of each inverter being given by a reference space vector; and
a controller to control each of the two three-phase inverters by an activation sequence of space vectors implementing the current conversion method according to claim 9.
